(19) United States
(12) Patent Application Publication
(10) Pub. No.: US 2017/0251342 A1
(43) Pub. Date: Aug. 31, 2017

(54) GROUP COMMUNICATION WITH A LOGICAL GROUP OF WIRELESS DEVICES OPERATING IN DIFFERENT NETWORKS

(71) Applicants: Rajesh BHALLA, Ghanna, OH (US); ZTE Corporation, Shenzhen (CN)

(72) Inventor: Rajesh Bhalla, Gahanna, OH (US)

(21) Appl. No.: 15/516,641

(22) PCT Filed: Oct. 2, 2015
(86) PCT No.: PCT/US2015/053848

§ 371 Date: Apr. 3, 2017

Related U.S. Application Data
(60) Provisional application No. 62/059,103, filed on Oct. 2, 2014.
(60) Provisional application No. 62/062,193, filed on Oct. 10, 2014.
(60) Provisional application No. 62/078,248, filed on Nov. 11, 2014.
(60) Provisional application No. 62/105,654, filed on Jan. 20, 2015.

(51) Int. Cl. H04W 4/08; H04W 4/14; H04W 8/04; H04W 8/18; H04W 8/20

(52) U.S. Cl. CPC H04W 4/08; H04W 8/186; H04W 8/205; H04W 8/04; H04W 4/14

(57) ABSTRACT

A server in a communication network performs group communication with a logical group of wireless devices by reserving network bandwidth, e.g., a logical identifier, that identifies a logical group of devices, tracking current locations of the member devices and delivering a message to the group based on individualized communication methods using the tracked locations of the member devices.

### CROSS REFERENCE TO RELATED APPLICATIONS

This patent document claims the benefit of priority of U.S. Provisional Patent Application No. 62/059,103, filed on Oct. 2, 2014; U.S. Provisional Patent Application No. 62/062,193, filed on Oct. 10, 2014; U.S. Provisional Patent Application No. 62/078,248, filed on Nov. 11, 2014; and U.S. Provisional Patent Application No. 62/105,654, filed on Jan. 20, 2015. The entire contents of the before-mentioned patent applications are incorporated by reference as part of the disclosure of this document.

### BACKGROUND

This application relates to wireless communications.

Wireless cellular networks today provide coverage to almost all areas where humans can reach. Even in remote areas, it is not uncommon to find wireless connectivity for data and voice communication. The wireless connectivity in different locations may be quite different in terms of the bandwidth and other services available to a user device.

### SUMMARY

The present document discloses techniques for performing communication with a group of wireless devices that may be operating in different networks, and the different networks their own, different, access protocols.

In one aspect, a technique implemented at a network-side server in a wireless communication network is disclosed. The technique includes reserving a network resource that identifies a logical group of wireless devices, tracking current locations and identities of devices that are members of the logical group of devices, and delivering a group message to members of the logical group of devices.

In another aspect, the embodiments provide a simple mechanism for the selection of the method of delivery of group messages at a service creation entity function (SCEF). The mechanism is based on the approach wherein network capabilities (such as 3GPP network capabilities) are not exposed to the service capability server/application server (SCS/AS). In these embodiments, the actual method of delivery of messages to user equipment (UEs) is selected at the SCEF and is transparent to the SCS/AS.

Some disclosed embodiments are based on simple enhancements to the solution for “Group Addressing and Identifiers”, and leverages the subscription data already available at the home subscriber server (HSS). These embodiments uses the existing service delivery methods without any modifications. Local caching of grouping information, service delivery capabilities, their associated parameters and policies at the SCEF reduces the impact on the core network nodes from frequent queries that are likely to return the same information as that already known to the SCEF. These embodiments neither impact the UEs nor the bearer nodes that perform service delivery.

These, and other, aspects are further described below with reference to the drawings.

### BRIEF DESCRIPTION OF THE DRAWINGS

FIG. 1 shows an example of a wireless communication system.

FIG. 2 shows an example of a radio station architecture.

FIG. 3 shows an example flowchart for a method of group communication with a logical group of wireless devices operating in different wireless networks.

FIG. 4 shows an example a wireless communication apparatus.

FIG. 5 shows an example of a system architecture for selecting the group message delivery method at the SCEF.

FIG. 6 shows an example flowchart for identification of message delivery services and group members.

FIG. 7 shows an example flowchart for selection of method of delivery for group messages.

FIG. 8 shows an example of a network configuration for group wireless communication.

FIG. 9 shows an example of messages exchanged for group communication with a logical group of wireless devices.

FIGS. 10A-10C show examples of messages exchanged for group communication with a logical group of wireless devices.

### DETAILED DESCRIPTION

Some network applications involve communication to and from a group of devices, with each group involving 100 s or 1000 s of devices. This document discloses a method for the delivery of Group Messages using different message delivery mechanisms to a group of devices (UEs) within a geographic area. It is possible that the UEs that are members of the same logical, or target, group may have different capabilities and connectivity. The messages may also need to be delivered across different areas of the same public land mobile network (PLMN) with different capabilities, different radio access technologies or even spread across different PLMNs.

Some popular mobile applications, such as Twitter and WhatsApp, provide application-layer connectivity to a group of users, by which, one user can transmit his messages (audio/text/image) to a group of users. These technologies, however, lack a notion of a geographical association of the group. Furthermore, because the groups are formed at application layer, typically at the web servers operated by Twitter and WhatsApp, the actual messaging to multiple wireless users within the same cell occurs on unicast messages to the users, thereby un-necessarily wasting the wireless bandwidth.

It will be beneficial to have flexible modes of operation. For example, a user may want to subscribe to various group communication systems (GCS) based on content type, such as conversational type communication (e.g., voice, video) or streaming (e.g., video) or data (e.g., messaging) or a combination of some of the types. Such services can also allow users to participate in several groups at the same time, in parallel; e.g., voice to one group, different streams of video or data to other groups etc. Furthermore, in some applications, a group may have to be formed on a temporary basis, e.g., when responding to disasters such as fire, earthquake and so on, and then terminated after the need for the group is passed. In one example scenario, firefighters or police assembled at a scene of disaster may form a service group based on their geographic location. Other fire fighters, who are not at the scene, may automatically be excluded from this group to conserve the communication bandwidth. Optionally, some fire fighters (e.g., a fire chief) may be included by overruling the geographic restrictions.

In this context, Cell Broadcast Service (CBS) and Multimedia Broadcast Multimedia Service (MBMS) provide methods for the delivery of service data from one sender to multiple users. Additionally, other methods exists for delivery of messages from an Application Server to the UEs such as by using unicast SMS via T4/Tsms, WiFi, landline broadband, satellite links, among others.

CBS and MBMS can be used to deliver the same message to a group of devices (UEs) within a geographic area. It is possible for different geographic areas in a PLMN to support different message delivery capabilities. It is also possible that different UEs that are member of the same group to have different capabilities, thus requiring the use of different service delivery methods within a given geographic area. Yet some other geographic areas may not support only unicast SMS via T4/Tsms.

Several organizations such as the 3GPP (3rd Generation Partnership Project) and 3GPP2 (Third Generation Partnership Project 2) are developing solutions for supporting group communications services over Long Term Evolution (LTE), Evolved Universal Terrestrial Radio Access (LTE/E-UTRAN) and cdma2000 technologies for Public Safety and other commercial applications. The term “GCSE” (Group Communication System Enabler) is used to refer to such Group Communication capabilities in the respective networks. In actual implementations, GCSE may refer to a service, software module(s) and/or hardware platform(s). While, for the sake of illustration, various techniques are disclosed with reference to the 3GPP EPS (Evolved Packet Core) networks, similar techniques are applicable for other communication networks as well. Unless otherwise mentioned, the abbreviations used in the present document as consistent with the terminology used in 3GPP documents. This document discloses systems and methods for the delivery of Group Messages using different message delivery mechanisms to a group of devices (UEs) within a geographic area where the UEs that are members of the same group may have different capabilities.

In some embodiments, the messages may have to be delivered across different areas of the same PLMN, with different areas supporting different message delivery capabilities, different radio access technologies, and so on. The methods and apparatus disclosed in the present document can be deployed within the communication networks, such as the 3GPP and 3GPP2 networks, for efficiently communicating with multiple wireless devices in a logical group using a communication connection that suits each device at the time of the transmission of the communication.

In some embodiments, the following operational parameters may be taken into account when delivering a message to a group: Serving PLMN and UE capability; and availability of message delivery mechanism(s) and radio access technology within the geographic area where the message needs to be delivered.

As an example, if CBS or eMBMS based messaging were to be introduced, the same message to a group may need to be delivered using different delivery mechanisms, e.g., for some devices using CBS, for some using eMBMS, for some using unicast SMS such as via T4/Tsms. Several embodiments cover different approaches on how and where the selection of group message delivery can happen. In some exemplary embodiments, the approach on how and where the selection of group message delivery can happen requires the Application Server to decide how to reach devices within a group, i.e. which delivery mechanism to use. This requires the network system to expose to the Application Server which delivery mechanism(s) are available to each UE within a group.

Other embodiments follow an approach wherein the services exposed to the Application Server are such that the actual delivery mechanism to the UEs within a group is transparent to the Application Server. In these embodiments, message delivery method selection is performed based on: UE capabilities; location of the UE, and the capabilities of the serving PLMN(s) at that location; geographic Area in which the message needs to be delivered. In this embodiments, the system may also consider the message size and the operator's policy or SLA agreement with application provider. The system may take into consideration the number of group members within a certain location when deciding the message delivery mechanism(s).

In some embodiments disclosed herein, it is generally assumed that the network system such as 3GPP supports eMBMS and unicast SMS via T4/Tsms message delivery mechanisms, but could be extended to support other message delivery mechanisms.

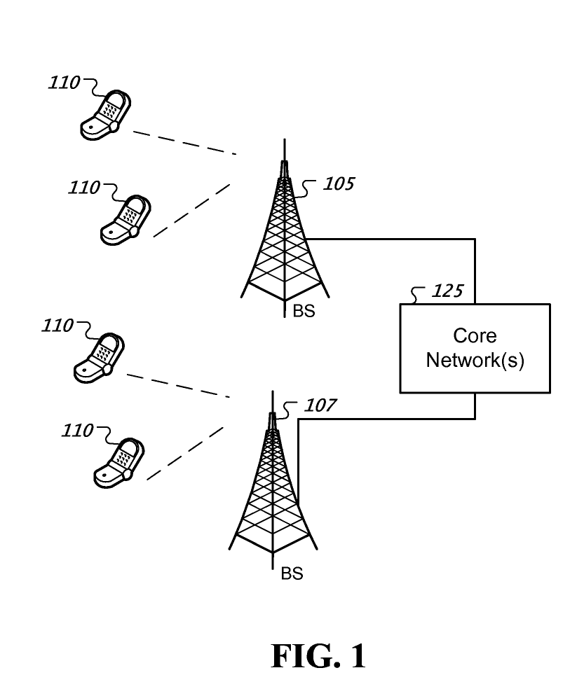

FIG. 1 shows an example of a wireless communication system. A wireless communication system can include one or more base stations (BSs) 105, 107, one or more wireless devices 110, and an access network 125. A base station 105, 107 can provide wireless service to wireless devices 110 in one or more wireless sectors. In some implementations, a base station 105, 107 includes directional antennas to produce two or more directional beams to provide wireless coverage in different sectors.

The access network 125 can communicate with one or more base stations 105, 107. In some implementations, the access network 125 includes one or more base stations 105, 107. In yet other some implementations, the access network 125 is in communication with a core network (not shown in FIG. 1) that provides connectivity with other wireless communication systems and wired communication systems. The core network may include one or more service subscription databases to store information related to the subscribed wireless devices 110. A first base station 105 can provide wireless service based on a first radio access technology, whereas a second base station 107 can provide wireless service based on a second radio access technology. The base stations 105, 107 may be co-located or may be separately installed in the field according to the deployment scenario. The access network 125 can support multiple different radio access technologies.

These embodiments may use different wireless communication systems and access networks including, wireless communication systems based Code Division Multiple Access (CDMA) such as CDMA2000 1x, High Rate Packet Data (HRPD), evolved HRPD (eHRPD), Universal Mobile Telecommunications System (UMTS), Universal Terrestrial Radio Access Network (UTRAN), Evolved UTRAN (E-UTRAN), Long-Term Evolution (LTE), and Worldwide Interoperability for Microwave Access (WiMAX). In some embodiments, a wireless communication system can include multiple networks using different wireless technologies. A dual-mode or multi-mode wireless device includes two or more wireless technologies that could be used to connect to different wireless networks. In some embodiments, a wireless device can support Simultaneous Voice-Data Operation (SV-DO).

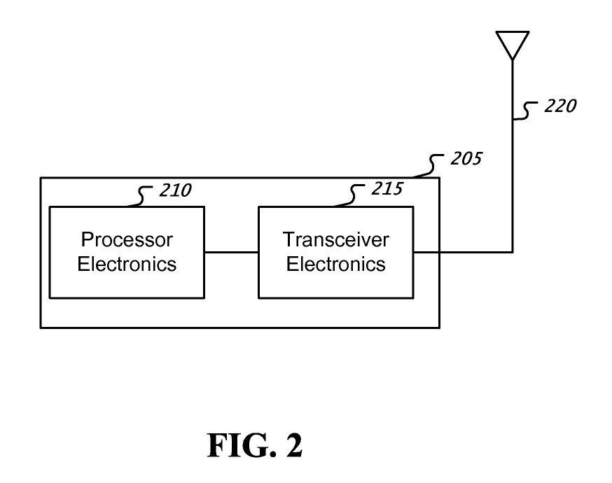

FIG. 2 shows an example block diagram representing a portion of a radio station 205. A radio station 205 such as a base station or a wireless device can include processor electronics 210 such as a microprocessor that implements one or more of the wireless techniques disclosed here. The radio station 205 can include transceiver electronics 215 to send and/or receive wireless signals over one or more communication interfaces such as antenna 220. The radio station 205 can include other communication interfaces for transmitting and receiving data. Radio station 205 can include one or more memories configured to store information such as data and/or instructions. In some implementations, the processor electronics 210 can include at least a portion of the transceiver electronics 215. In some embodiments, at least some of the disclosed techniques, modules or functions are implemented using the radio station 205.

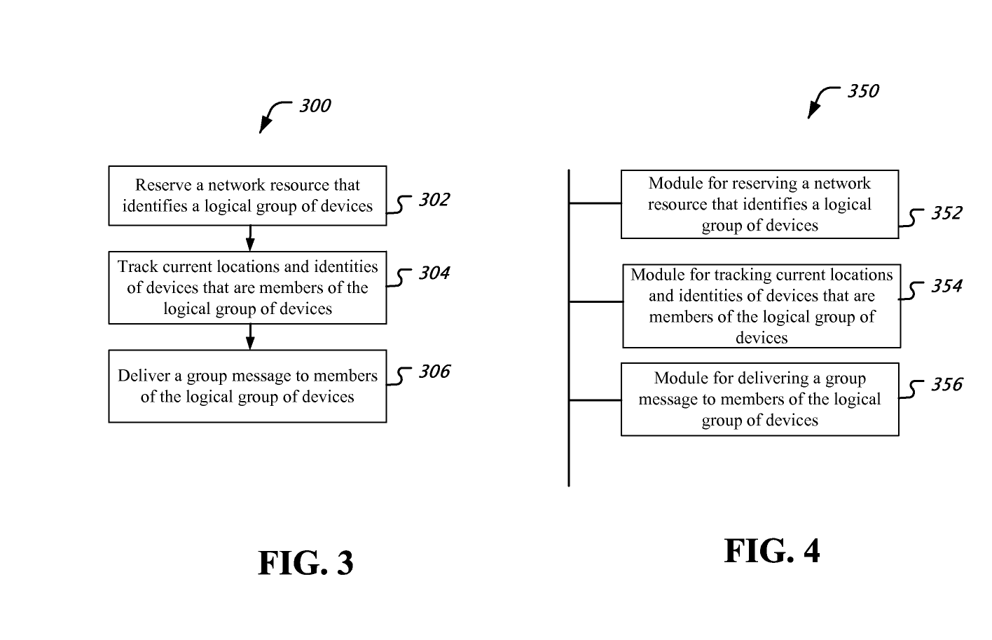

FIG. 3 shows a flowchart for an example method 300 for group communication. At 302, the method 300 includes reserving a network resource that identifies a group of devices. The group of devices may be a logical group that is formed through an explicit request by the users of the devices, e.g., users using a social media application. The group may also be formed without an explicit request from users or the devices themselves. For example, a network operator may form a logical group of devices that all have a same software release version, thus facilitating simultaneous notification of code upgrades to the devices. As described herein, in some embodiments, the network resource reservation may include assigning a temporary mobile group identification to the logical group. The group identification may be, e.g., used during the life time of the formation and operation of the logical group, and thereafter may be de-assigned from the group and used in future for another group.

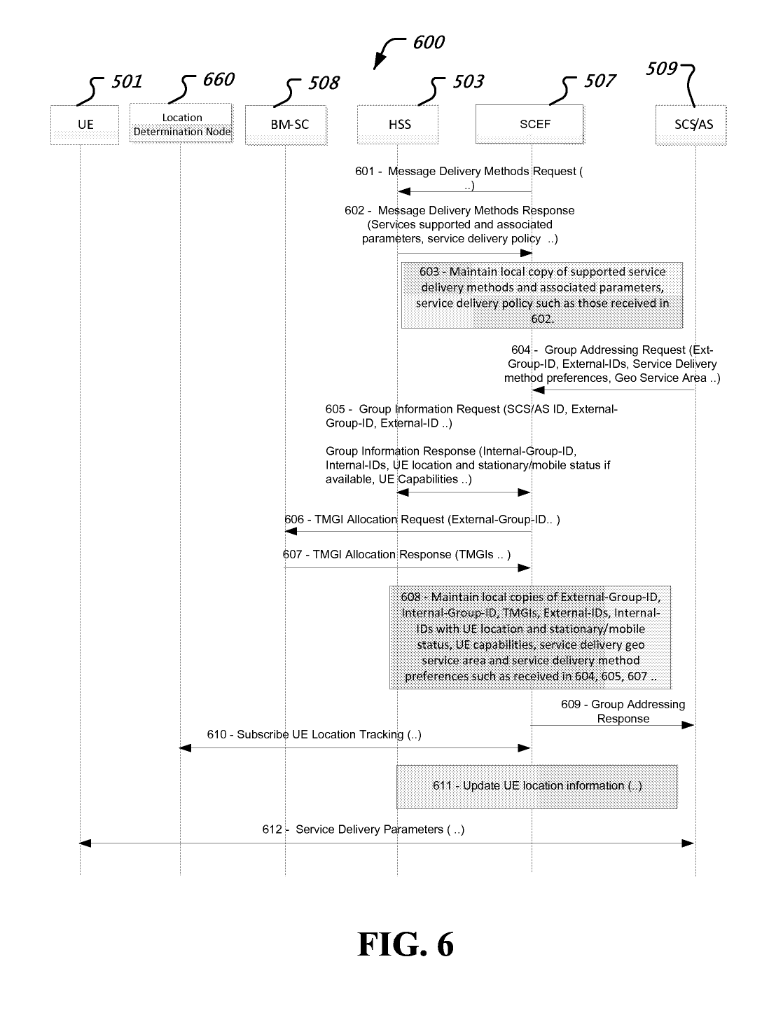

In some embodiments, the network resource reservation may be performed by transmitting a request to broadcast multicast service center (BM-SC) to reserve a group identification and receiving the group identification from the BM-SC. Various embodiments of messages exchanged with BM-SC are shown in FIGS. 6, 7, 9 and 10A-10C. In some embodiments, the network resources may already be set aside for group communication, based on an operator policy.

At 304, the method 300 includes tracking current locations and identities of devices that are members of the logical group of devices. Some example tracking techniques are described herein. In some embodiments, the tracking is performed by receiving information about a user device's location from the user device's subscription information in an HSS for the user device.

At 306, the method 300 includes delivering a group message to the members of the logical group of devices. Some examples of individualized methods of delivery to group members based on the capabilities of the network in which the members are operating at the time of delivery of the group message are disclosed in subsequent figures and accompanying text.

In some embodiments, the message is delivered to two different users using two different delivery procedures. For example, for a first user device that is currently located in a service area that provides a broadcast multicast service, the message is delivered using an eMBMS delivery procedure. Also, for a second user device that is currently outside of the service area that provides the broadcast multicast service, the message is delivered using a short messaging service (SMS) delivery procedure.

FIG. 4 shows an example system 350 for group communication. The system 350 includes a module 352 for reserving a network resource that identifies a group of devices. The group of devices may be a logical group that is formed through an explicit request by the users of the devices, e.g., users using a social media application. The group may also be formed without an explicit request from users or the devices themselves. For example, a network operator may form a logical group of devices that all have a same software release version, thus facilitating simultaneous notification of code upgrades to the devices.

The system 350 includes a module 354 for tracking current locations and identities of devices that are members of the logical group of devices. Some example tracking techniques are described in subsequent figures and accompanying text.

The system 350 includes a module 356 for delivering a group message to the members of the logical group of devices. Some examples of individualized methods of delivery to group members based on the capabilities of the network in which the members are operating at the time of delivery of the group message are disclosed in subsequent figures and accompanying text. The system 350 and modules 352, 354, 356 may further implement the techniques disclosed with respect to the method 300.

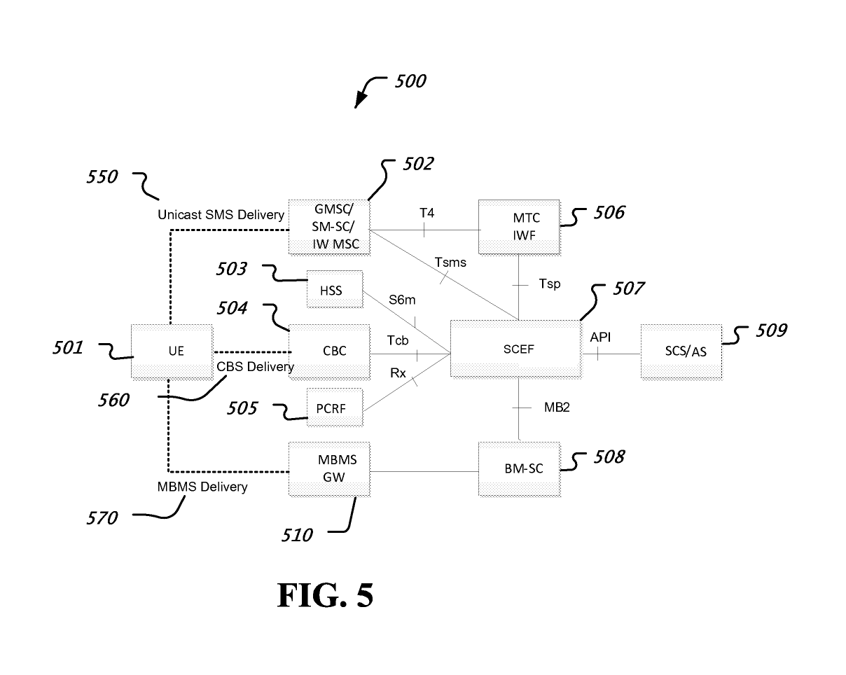

FIG. 5 shows an example system 500 for group communication providing for the selection of group message delivery method at the SCEF 507. The SCEF 507 communicates with the HSS 503 to determine the service delivery capabilities (e.g. CBS, MBMS, or other) supported by the PLMN and their respective geographic coverage areas. HSS 503 also provides service delivery policy information, such as the preferred mode of message delivery. Alternatively, such information may be configured at the SCEF 507. This system 500 may be enhanced for PLMNs that support other service delivery capabilities such as WiFi, landline broadband, satellite links, etc.

The exemplary embodiment in FIG. 5 covers the approach wherein the network capabilities (such as 3GPP network capabilities) are not exposed to the SCS/AS. The SCEF 507 selects the method of delivery of group messages to the UEs 501 and the actual method of delivery of messages to the UEs 501 is transparent to the SCS/AS 509.

In this exemplary embodiment, message delivery method selection is performed at the SCEF 507 based on, among other criteria, the UE capabilities; location of the UE, and the capabilities of the serving PLMN(s) at that location; and the geographic area in which the message needs to be delivered.

In selecting the method of delivery of group messages to the UEs 501, the exemplary system 500 may also consider, among other considerations, the message size, and the operators' policy or SLA agreements with application provider.

The exemplary system 500 may also take into consideration the number of group members within a certain location when deciding the message delivery mechanism(s).

In other exemplary embodiments, the SCEF 507 may include functionality such as CBE for CBS, and GCS-AS for eMBMS. Other possible configurations, such as CBE and GCS-AS as separate functional entities may also be supported.

SCEF 507 also contains Group Management Function (GMF). Through GMF function, the SCEF maintains a local copy of the binding of Internal-IDs (e.g. IMSI) and External-ID (e.g. MSISDN) of group members with the group's Internal-Group-ID and External-Group-ID. Other grouping information such as TMGIs allocated to the groups for MBMS service, cell broadcast channel, geographic area for the delivery of group messages, policy regarding the preferred mode of message delivery and location information for the UEs can also be maintained at the GMF.

Based on service layer interactions, the SCS/AS 509 forwards the Group Message to SCEF 507 along with the External-Group-ID. The SCEF 507 may know the identity of the UEs (UE Internal IDs/IMSIs) that belong to this group, either based on its cached information or via interactions with the HSS 503, as needed.

In some exemplary embodiments, the geographic area for the delivery of the Group Message may be passed by the SCS/AS 509 to the SCEF 507 or obtained from the HSS 503. If the geographic area in which the UEs of the group are located is known in the SCEF 507, and if the group message has to be delivered in this whole geographic area, the geographic area information does not have to be sent over by the SCS/AS 509 along with the Group Message. The UEs that are within the scope of broadcast service coverage areas (e.g. CBS, MBMS) are targeted via such services within their respective geographic coverage areas using the preferred mode of message delivery. For UEs located outside the broadcast service coverage areas, the SCEF 507 uses unicast SMS via T4/Tsms 550 for the delivery of group messages.

FIG. 6 shows an example flowchart 600 for the identification of message delivery services supported by the PLMN, and the identification of group members that belong to the group identified by External-Group-ID.

At 601, SCEF 507 requests HSS 503 for, among other information, information about message delivery services supported by the PLMN, service delivery policies and parameters, etc.

At 602, the HSS 503 returns information about the message delivery services that it supports along with associated parameters, including but not limited to, service coverage areas; serving nodes and associated parameters such as cell broadcast channel (for CBS), frequency, schedule, etc.; and service delivery policies, where such policies could be based on configuration and/or agreements with the Application Service Provider.

Different exemplary embodiments may include one or more service delivery methods at 602 including broadcast services such as CBS and MBMS,unicast SMS via T4/Tsms, as well as service delivery via WiFi, landline broadband, satellite links, etc.

In some embodiments, the service delivery policy at 602 may also include information such as the preferred method of service delivery based on geographich areas, preferred method of service delivery based on time of day and quality of service subscribed by the ASP, contractual obligations with the ASP, etc.

At 603, the SCEF 507, using its internal GMF, maintains a local copy the information received in 602.

At 604, SCS/AS 509 requests the SCEF 507 to support an application specific group by sending a Group Addressing Request message. The message includes the External-Group-ID and the External-IDs of the devices (UEs) that are member of the external group. Other group-specific information such as the geographic serivce area, and prefered methods for service delivery can also be included.

At 605, the SCEF 507 exchanges Group Information Request/Response messages with the HSS 503 to determine if the SCS/AS 509 is authorized to send a Group Information Request for the External-Group-ID. The HSS 503 maps the received group member External-IDs to Internal-IDs. The External-Group-ID may be mapped to Internal-Group-ID if such information is available at the HSS. The HSS returns the mapped External-IDs to Internal-IDs and Internal-Group-ID, if available. UE capabilities, location information of the group members (UEs) and their stationary/mobile stauts, if known, can also returned to the SCEF 507.

At 606, if MBMS services are supported by the PLNM, the SCEF 507 requests for the BM-SC 508 to allocate TMGIs for the group by sending TMGI Reservation Request message to the BM-SC.

At 607, BM-SC 508 reserves TMGIs for the group and informs SCEF 507 via TMGI Reservation Response message.

At 608, SCEF 507, using its internal GMF, maintains a local copy of the mapping of External-Group-ID with information such as group member Internal-IDs, and Internal-Group-ID (if available) associated with the group members, UE capabilities, group member (UE) location information and their stationary/mobility status as provided by the HSS. Other group-specific information such as the allocated TMGIs, geographic service area, preferred methods for service delivery, etc., such as those received in 604, 605 and 607 are saved in the local copy at the SCEF 507. The local copy of such information is kept so as to reduce the impact on core network nodes from frequent queries that are likely to return the same information as that already known to the SCEF 507.

At 609, the SCEF 507 confirms to the SCS/AS 509 with a Group Addressing Response message.

At 610, the SCEF 507 may request the network node(s) to subscribe to UE location tracking, if needed. UE location information for stationary devices (UEs) can be provided by the HSS 503 at 605.

At 611, SCEF 507 updates UE location information as it becomes available. Appropriate location tracking procedures can be used depending on the frequency and granularity of location information tracking needed. ULI reporting via PCRF is one of the example methods for location information tracking. Location information of the UEs that are outside the Geo Service Area can be marked as “out-of-service area”. Group messages are not delivered to such UEs.

At 612, if configured to do so, the UEs obtain the service delivery bearer parameters from the SCEF 507, e.g., using a known address such as an FQDN for the SCEF. Alternatively, such parameters can be signalled by the SCEF to all group members. Such parameters include cell broadcast message IDs, cell broadcast channel (for CBS), TMGIs (for MBMS) frequency, schedule, etc., that the UE can use for listening to broadcast messages. Alternatively pre-configuration and/or over-the-top procedures such as OMA procedures can be used to configure such parameters at the UEs.

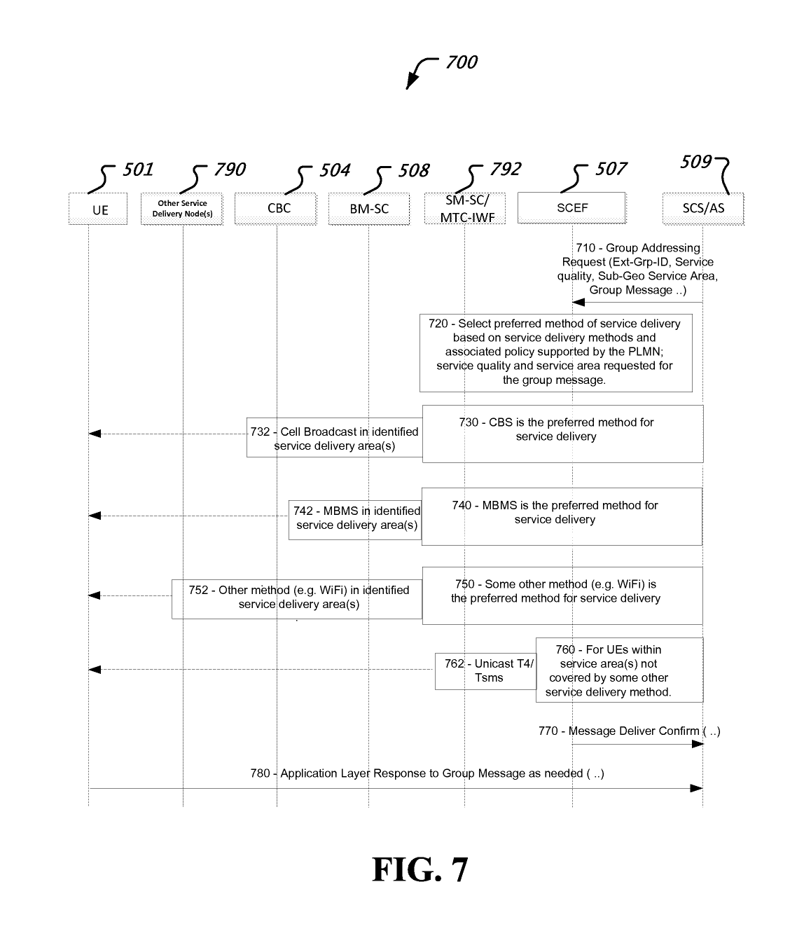

FIG. 7 shows an example flowchart 700 for the selection of the method of delivery for the group messages at the SCEF 507.

At 710, SCS/AS 509 sends Group Message Delivery Request message containing the group message to the SCEF 507. External-Group-ID identifies the group of devices that are to receive this group message. Desired service quality (e.g. Gold, Silver, Bronze, etc.), and sub-geo service area for the delivery of the group message can also be included.

In some exemplary embodiments where the group message has to be delivered in the whole geographic area, sub-geo service area information does not have to be sent over by the SCS/AS 509 along with the group message.

At 720, from the group service specific information cached at the SCEF 507 (at 603, 608, and 611 in FIG. 6), the SCEF determines the preferred method of service delivery for the UEs that are within the Geo/Sub-geo service area. UE capability information and desired service quality can also be considered for the determination of the preferred method(s) of service delivery.

At 730, for service coverage areas where cell broadcast is the preferred method of service delivery, the SCEF 507 interacts with the designated CBC node(s) 504 for the delivery of cell broadcast service. Information regarding the designated CBC node(s) and associated CBS service delivery parameters are cached at the SCEF (at 603, 608, and 611 in FIG. 6).

At 740, for service coverage areas where MBMS is the preferred method of service delivery, the SCEF 507 interacts with the designated BM-SC node(s) 508 for the delivery of MBMS service. Information of the designated BM-SC node(s) and associated service delivery parameters are cached at the SCEF (at 603, 608, and 611 in FIG. 6).

At 750, for service coverage areas where some other service delivery method (e.g. WiFi) is the preferred method of service delivery, the SCEF 507 interacts with the designated service delivery node(s) for the delivery of such other services. Information of the designated service node(s) and associated service delivery parameters are cached at the SCEF (at 603, 608, and 611 in FIG. 6).

At 760, for UEs not covered by any other preferred service delivery method, unicast SMS via T4/Tsms 762 is used for the delivery of group message.

At 770, SCEF 507 confirms delivery of the Group Message to the SCS/AS 509 as needed.

At 780, on receving the payload in the group message, the UEs communicate individually with the SCS/AS 509 at the Application Layer, as needed.

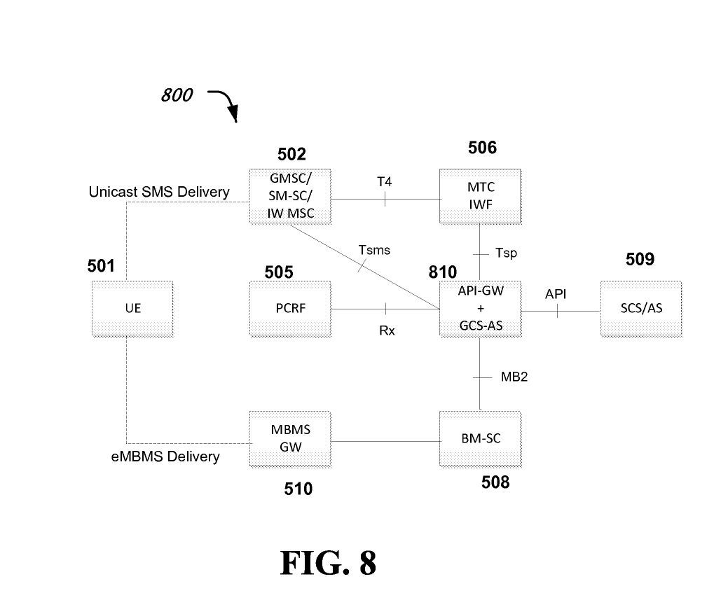

FIG. 8 shows an example of a network 800 that allows the selection of the method for the delivery of Group Messages for a 3GPP system that supports eMBMS and unicast SMS via T4/Tsms message delivery mechanisms. The illustrated procedure can be enhanced to support other message delivery mechanisms as well.

In the network architecture illustration 800, the API-GW and GCS-AS 810 are shown as a single entity 810 which may be implemented on a single software or hardware platform. One method of interaction between API-GW and GCS-AS can be for the API-GW and the GCS-AS functions to be integrated in a single entity. In another configuration, the API-GW and GCS-AS interact over an interface. Such interface could be a standardized interface or a service provider specific interface.

Based on service layer interactions, the SCS/AS 509 forwards a Group Message to API-GW/GCS-AS 810 for delivery to a group of devices that are identified by Group-ID. API-GW/GCS-AS knows the identity of the UEs 501 (UE Internal IDs/IMSIs) that belong to the group. The geographic area for the delivery of the message is also known to the API-GW/GCS-AS or can be passed by the SCS/AS 509 along with the Group Message. The UEs 501 that support eMBMS and are within the scope of the eMBMS geographic area (MBMS SAIs) are targeted via eMBMS delivery. For other UEs, the API-GW/GCS-AS 810 uses unicast SMS via T4/Tsms for the delivery of the Group Message.

The other entities depicted in the exemplary network 800 include: Policy and Charging Rules Function PCRF 505, Mobile Switching Center (MSC)/Gateway MSC (GMSC)/Short Message Service Center (SMSC) 502, Machine Type Communication Interworking Function (MTC IWF) 506, Multimedia Broadcast Multicast Service (MBMS) Gateway (GW) 510 and Broadcast Multicast Service Center (BM-SC), which have their usual meanings as described in 3GPP documents such as TS 23.002 Network Architecture, and 3GPP TS 32.373, incorporated by reference herein in their entirety.

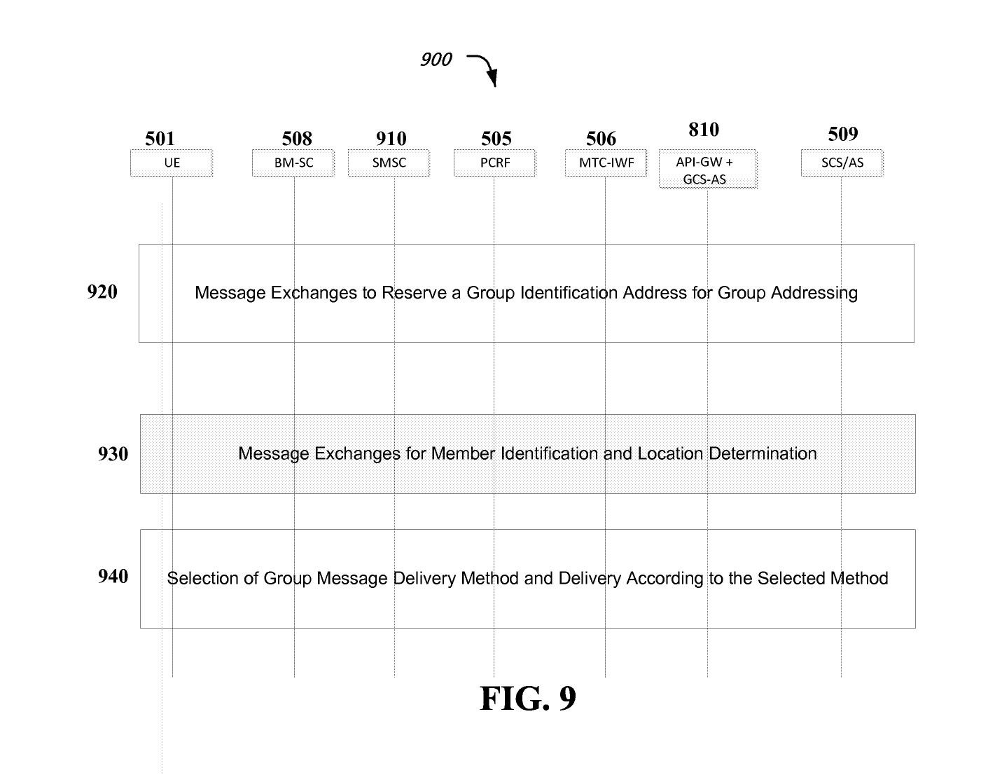

FIG. 9 illustrates an example procedure for the selection of the method for delivery of Group Messages to a group of devices. At 920, messages are exchanged to reserve a group identification address for logically grouping multiple UEs for group addressing. At 930, messages are exchanged for identifying locations of member UEs at current times. At 940, a group message delivery method is selected based on the determined locations and messages are delivered according to the selected methods.

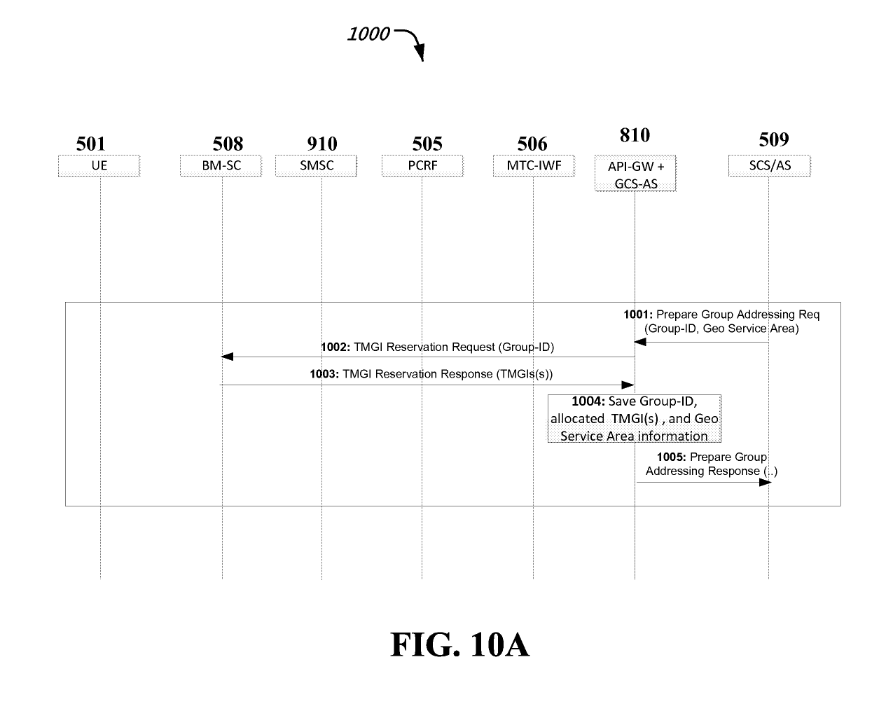

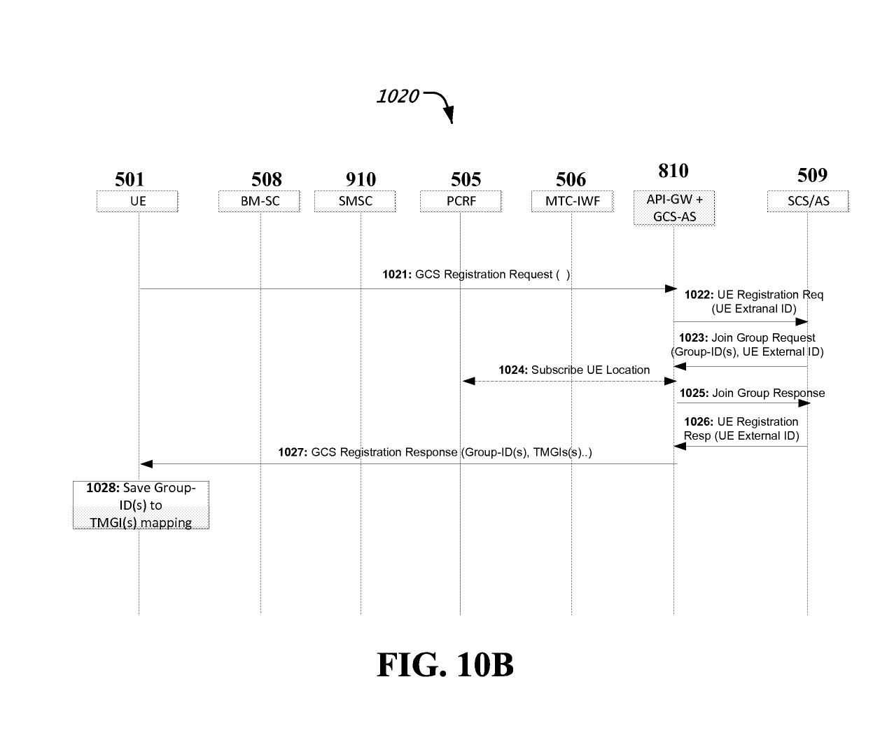

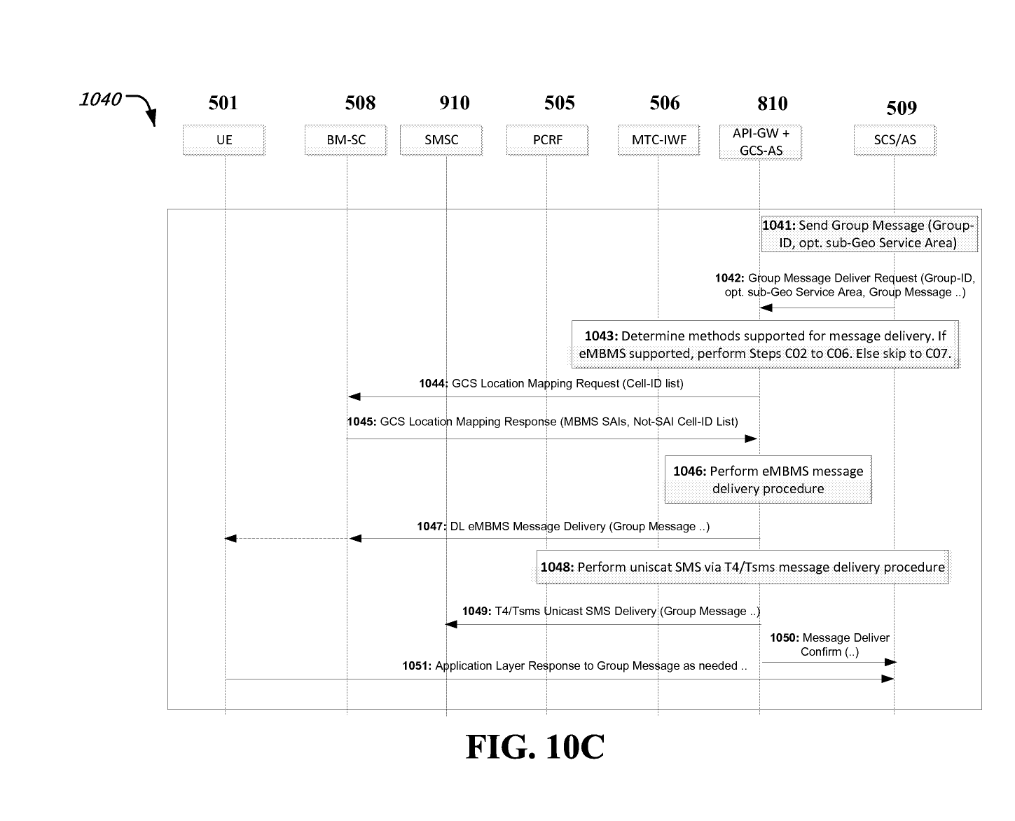

FIG. 10A provides examples of messages exchange 1000 during one phase of reserving TMGI (temporary mobile group identification) for group addressing. The SCS/AS requests the API-GW/GCS-AS to reserve TMGI(s) for addressing devices in a group that is identified by Group-ID. The API-GW/GCS-AS requests the BM-SC to reserve TMGI(s) for the group. API-GW/GCS-AS saves the information about Group-ID and allocated TMGI(s).

At 1001, SCS/AS 509 requests API-GW/GCS-AS 810 to prepare for group addressing by sending Prepare Group Addressing Request message. The message includes Group-ID, and may include the Geo Service Area information also that identifies the geographic area within which group message delivery is to be restricted. When Geo Service Area information is not provided, the group message is delivered across the PLMN service area.

At 1002, API-GW/GCS-AS 810 sends TMGI Reservation Request to BM-SC with Group-ID information.

At 1003, BM-SC 508 reserves TMGI(s) for the group and informs API-GW/GCS-AS 810.

At 1004, 1005, API-GW/GCS-AS 810 saves information about the allocated TMGI(s) and the Geo Service Area associated with the Group-ID, and confirms to SCS/AS 509. As an alternative, TMGI(s) may be assigned via pre-configuration—based on operator policy, SCS/AS service provider and 3GPP network operator collaborate in the pre-configuration of TMGI(s) for groups identified by Group-IDs.

FIG. 10B shows example messages exchange 1020 for identifying members of the group and their location information. The device (UE) 501 performs GCSE registration with the API-GW/GCS-AS 810. API-GW/GCS-AS forwards UE Registration Request along with UE External ID to the SCS/AS 509. From UE External ID, SCS/AS determines the groups (Group-IDs) that the device (UE) is a member of. SCS/AS sends Join Group Request with Group-ID(s) to the API-GW/GCS-AS 810. The API-GW/GCS-AS 810 associates/maps the UE 501 as a member to the respective groups and starts tracking UE location information, e.g., by using ULI procedures with the PCRF 505.

For stationary devices, location information could be part of subscription information that the API-GW/GCS-AS 810 can obtain from the HSS. In this case location tracking of the UEs is not needed. After the UE successfully joins as member of its associated group(s), the API-GW/GCS-AS informs the UE about the TMGI(s) that are allocated to the Group-IDs. In some embodiments, the tracking is thus responsive to mobility of the UE, i.e., whether the UE is mobile or stationary.

At 1021, GCSE Application on the UE 501 registers with the API-GW/GCS-AS 810.

At 1022, API-GW/GCS-AS 810 forwards UE 501 Registration Request to the SCS/AS 509. UE Registration Request includes UE's External ID.

At 1023, SCS/AS 509 determines the groups that the device (UE) is a member of and sends Join Group Request message to the API-GW/GCS-AS 810. Group-ID of the group that the device (UE) is subscribed to is included in the Join Group Request message. For devices subscribed to multiple groups, multiple Group-IDs are sent by the SCS/AS. The API-GW/GCS-AS associates/maps the UE as member of the group(s) identified by Groups-ID(s). HSS interrogation may be needed to map UE External ID to UE Internal ID.

At 1024, API-GW/GCS-AS 810 requests the PCRF 505 to subscribe to UE location information. ULI procedure is invoked to retrieve UE location. When UE changes location, the PCRF is aware of the change of location and reports it to the API-GW/GCS-AS with appropriate reporting frequency. Such UE location information can be in the form of Cell-ID. For stationary devices (UEs) the HSS can provide location information of the UE to the API-GW/GCS-AS. API-GW/GCS-AS stores UE location information along with UE group membership information.

Whereas ULI reporting via PCRF is one of the methods for location information tracking, other location tracking procedures can also be used for this purpose.

Group membership information of the UEs that are outside the Geo Service Area is marked as “out-of-service area”. Group messages are not delivered to such UEs.

At 1025, 1026, API-GW/GCS-AS informs SCS/AS of UE's successful joining of the Groups(s), and SCS/AS acknowledges with UE Registration Response message.

At 1027, API-GW/GCS-AS 810 sends GCS Registration Response to the UE that includes the TMGI(s) for the group(s) that the Applications on the UE are subscribed to.

At 1028, the UE maintains the mapping of the TMGI(s) and the group identifiers and monitors the network to determine the availability of eMBMS transmission corresponding to the TMGI(s) for the interested groups.

For UEs that do not support eMBMS, Application Layer registration with SCS/AS 509 triggers the join group request in 1023, the subscribe to UE location in 1024, and the join group response at 1025, allowing the UE to join the group(s) that it is subscribed to. Such UEs are marked as non-eMBMS capable. Unicast SMS via T4/Tsms is used for the delivery of Group Messages to such UEs.

FIG. 10C shows example message exchange 1040 for Group Message delivery selection at API-GW/GCS-AS 810. On receiving a Group Message for a group of devices from the SCS/AS 509, the API-GW/GCS-AS 810 selects the method for the delivery of the message to UEs that are member of the group identified by Group-ID. For the PLMN that supports eMBMS, the API-GW/GCS-AS initiates eMBMS delivery procedure for delivering the message to the UEs. The UEs that are within the scope of MBMS SAI(s) associated with the Geo Service Area of the group can receive the Group Message via eMBMS. For the rest of the UEs within the Geo Service Area of the group, the API-GW/GCS-AS invokes unicast SMS delivery via T4/Tsms for the delivery of the Group Message.

At 1042, based on actions at the service layer, SCS/AS 509 sends Group Message Delivery Request containing the Group Message to the API-GW/GCS-AS 810. Group-ID identifies the group of devices that are to receive this Group Message. If group message delivery is to be restricted to a sub-set of the Geo Service Area configured for this group, Group Message Delivery Request message includes sub-Geo Service Area information as well.

At 1043, API-GW/GCS-AS 810 determines the methods for the delivery of the message that are supported by the PLMN. If eMBMS is supported, the API-GW/GCS-AS initiates eMBMS delivery procedure 1044-1047, otherwise it performs the unicast SMS delivery procedure 1048.

At 1044, API-GW/GCS-AS 810 sends GCS Location Mapping Request to BM-SC 508 for group member location mapping to MBMS SAI(s). List of the location for the UEs (Cell-IDs) that are member of the group (Group-ID) and are not marked as “out-of-service-area” is provided to the BM-SC 508. If the Group Message is to be delivered to UEs within a sub-Geo Service Area, the list of UE location (Cell-IDs) is limited to the member UEs that are within the sub-Geo Service Area.

At 1045, BM-SC 508 maps the given Cell-IDs to MBMS SAI(s) and sends a response carrying the list of MBMS SAI(s) to API-GW/GCS-AS 810. The response also includes the list of Cell-IDs that cannot be mapped to MBMS SAI(s).

At 1046, the API-GW/GCS-AS 810 determines that eMBMS delivery can be used for the delivery of the Group Message to the UEs in geo-areas that correspond to the received list of MBMS SAI(s).

At 1047, API-GW/GCS-AS 810 initiates the establishment of eMBMS bearers corresponding to the list of MBMS SAI(s) and sends DL eMBMS data carrying the Group Message. The UEs periodically monitor for the indicated TMGI(s) to receive the Group Message from the eMBMS data.

If at 1043 the API-GW/GCS-AS 810 determines that eMBMS is not supported by the PLMN, the API-GW/GCS-AS performs unicast SMS via T4/Tsms for delivering Group Message 1048 to all UEs that are within the Geo Service Area/sub-Geo Service Area. Unicast SMS via T4/Tsms delivery is used for Non-eMBMS capable UEs as well.

The determination of the methods supported for message delivery is based on the information available at the API-GW/GCS 810. Such information can be obtained by the API-GW/GCS-AS interactions with the HSS. Factors such as UE capabilities, location of the UE and the capabilities of the serving PLMN(s), geographic area in which the message needs to be delivered, consideration of the message size, operator's policy or SLA agreement with the application provider, etc., are considered for the selection of the method of message delivery.

If 1044-1047 is performed, unicast SMS via T4/Tsms for Group Message delivery is performed for UEs whose location (Cell-ID(s)) could not be mapped to MBMS SAI(s) at 1045, i.e., for UEs located within geographic area determined by “Not-SAI Cell-ID List” at 1045.

At 1049, API-GW/GCS-AS sends unicast SMS via T4/Tsms to the UEs identified in 1048. The SMS carries the Group Message received from SCS/AS.

At 1050, API-GW/GCS-AS confirms delivery of the Group Message to the SCS/AS.

At 1051, on receiving the information in the Group Message, the UEs communicate individually with the SCS/AS at the Application Layer, as needed.

The exemplary embodiments disclosed here may impact the SCEF in the following areas: support messages from the SCS/AS identified in the procedure flows in FIGS. 6, 7, 9, and 10A-10C; maintain information about the methods of service delivery supported by the PLMN and service delivery policies etc.; maintain mapping between the group identifier, geographic service areas, group membership and location of group members, as needed; invoke UE location tracking procedures, as needed; interact with BM-SC for the allocation of TMGIs for External-Group-IDs, as needed; and interact with the designated service delivery node(s) for the delivery of group messages, among other potential impacts.

The embodiments disclosed here may impact the HSS in the following areas: support interactions with the SCEF for providing information such as mapping of External-IDs to Internal-IDs, mapping External-Group-IDs to Internal-Group-IDs; support interactions with the SCEF for providing information about the methods for service delivery that are supported by the PLMN, associated parameters and policies, and designed service nodes for providing such message delivery services.

The following are example impacts to the GCS-AS component of API-GW/GCS-AS: support messages from the SCS/AS identified in the procedure flows in FIGS. 6, 7, 9, and 10A-10C, and interact with BM-SC for the allocation of TMGI(s) for Group-IDs; support delivery of Group Messages to geographic areas as requested by the SCS/AS; perform Rx interface procedure to collect UE location information; maintain mapping between the group identifier, geographic service areas, group members and location of group members; and interact with BM-SC for group member location mapping from cell identifiers to MBMS service area identifiers.

In some embodiments, to implement techniques disclosed herein, an existing BM-SC may be modified to support group member location mapping from cell identifiers to MBMS service area identifiers; and identify to the GCS-AS the cell identifiers that cannot be mapped to MBMS service area identifiers.

In some embodiments, an existing UE can be modified to include Application Layer specific functionality disclosed herein.

Some features of these and other embodiments could be described using the following clauses:

1. A method implemented at a network-side server in a wireless communication network, the method comprising: reserving a network resource that identifies a logical group of wireless devices; tracking current locations and identities of devices that are members of the logical group of devices; and delivering a group message to members of the logical group of devices.

2. The method of clause 1, wherein the network resource comprises a temporary mobile group identification.

3. The method of clause 1, wherein the reserving the network resource includes: transmitting a request to broadcast multicast service center (BM-SC) to reserve a group identification; and receiving the group identification from the BM-SC.

4. The method of clause 1, wherein the network resource is reserved a priori based on an operator policy.

5. The method of clause 1, wherein the tracking current locations includes: receiving information about a user device's location from the user device's subscription information in a home subscriber server (HSS) for the user device.

6. The method of clause 1, further including: delivering the message, for a first user device that is currently located in a service area provides a broadcast multicast service, using an eMBMS delivery procedure; and delivering the message, for a second user device that is currently outside of the service area that provides the broadcast multicast service, using a short messaging service (SMS) delivery procedure.

7. A communication apparatus comprising: a memory for storing instruction; and a processor for reading the instructions from the memory and implementing a method, comprising: reserving a network resource that identifies a logical group of wireless devices; tracking current locations and identities of devices that are members of the logical group of devices; and delivering a group message to members of the logical group of devices.

8. The apparatus of clause 7, wherein the network resource comprises a temporary mobile group identification.

9. The apparatus of clause 7, wherein the reserving the network resource includes: transmitting a request to broadcast multicast service center (BM-SC) to reserve a group identification; and receiving the group identification from the BM-SC.

10. The apparatus of clause 7, wherein the network resource is reserved a priori based on an operator policy.

11. The apparatus of clause 7, wherein the tracking current locations includes: receiving information about a user device's location from the user device's subscription information in a home subscriber server (HSS) for the user device.

12. The apparatus of clause 7, wherein the method further includes: delivering the message, for a first user device that is currently located in a service area provides a broadcast multicast service, using an eMBMS delivery procedure; and delivering the message, for a second user device that is currently outside of the service area that provides the broadcast multicast service, using a short messaging service (SMS) delivery procedure.

13. A communication network comprising a network-side server and a plurality of user equipment (UEs), wherein the UEs form a logical group of devices and wherein the network-side server: reserves a network resource that identifies the logical group; tracks current locations of UEs that are members of the logical group; and facilitates delivery of a group message to members of the logical group.

It will be appreciated that group communication techniques are described which allow for a network-side server such as an application server to simultaneously reach a logical group of mobile devices using a method of communication for each device that is best suited for the device as the time of the communication based on the location of the device and a communication method available to that device.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method implemented at a network-side server in a wireless communication network, the method comprising:
reserving a network resource that identifies a logical group of wireless devices;
tracking current locations and identities of devices that are members of the logical group of devices; and
delivering a group message to members of the logical group of devices.

2. The method of claim 1, wherein the network resource comprises a temporary mobile group identification.

3. The method of claim 1, wherein the reserving the network resource includes:
transmitting a request to broadcast multicast service center (BM-SC) to reserve a group identification; and
receiving the group identification from the BM-SC.

4. The method of claim 1, wherein the network resource is reserved a priori based on an operator policy.

5. The method of claim 1, wherein the tracking current locations includes:
receiving information about a user device's location from the user device's subscription information in a home subscriber server (HSS) for the user device.

6. The method of claim 1, further including:
delivering the message, for a first user device that is currently located in a service area provides a broadcast multicast service, using an eMBMS delivery procedure; and
delivering the message, for a second user device that is currently outside of the service area that provides the broadcast multicast service, using a short messaging service (SMS) delivery procedure.

7. A communication apparatus comprising:
a memory for storing instruction; and
a processor for reading the instructions from the memory and implementing a method, comprising:
reserving a network resource that identifies a logical group of wireless devices;
tracking current locations and identities of devices that are members of the logical group of devices; and
delivering a group message to members of the logical group of devices.

8. The apparatus of claim 7, wherein the network resource comprises a temporary mobile group identification.

9. The apparatus of claim 7, wherein the reserving the network resource includes:
transmitting a request to broadcast multicast service center (BM-SC) to reserve a group identification; and
receiving the group identification from the BM-SC.

10. The apparatus of claim 7, wherein the network resource is reserved a priori based on an operator policy.

11. The apparatus of claim 7, wherein the tracking current locations includes:
receiving information about a user device's location from the user device's subscription information in a home subscriber server (HSS) for the user device.

12. The apparatus of claim 7, wherein the method further includes:
delivering the message, for a first user device that is currently located in a service area provides a broadcast multicast service, using an eMBMS delivery procedure; and
delivering the message, for a second user device that is currently outside of the service area that provides the broadcast multicast service, using a short messaging service (SMS) delivery procedure.

13. A communication network comprising a network-side server and a plurality of user equipment (UEs),
wherein the UEs are configured to form a logical group of devices and wherein the network-side server is configured to:
reserve a network resource that identifies the logical group;
track current locations of UEs that are members of the logical group; and
facilitate delivery of a group message to members of the logical group.

14. (canceled)

15. The communication network of claim 13, wherein the network resource includes a group identification address.

16. A communication server comprising:
a memory configured to store data and instructions; and
a processor configured to read the instructions from the memory and to implement a method at a network-side server in a wireless communication network, the instructions comprising:
code for reserving a network resource that identifies a logical group of wireless devices;
code for tracking current locations and identities of devices that are members of the logical group of devices; and
code for delivering a group message to members of the logical group of devices.

17. The communication server of claim 16, wherein the network resource comprises a temporary mobile group identification.

18. The communication server of claim 16, wherein the code for reserving the network resource includes:
code for transmitting a request to broadcast multicast service center (BM-SC) to reserve a group identification; and
code for receiving the group identification from the BM-SC.

19. The communication server of claim 16, wherein the network resource is configured to be reserved a priori based on an operator policy.

20. The communication server of claim 16, wherein the code for tracking current locations includes:
code for receiving information about a user device's location from the user device's subscription information in a home subscriber server (HSS) for the user device.

21. The communication server of claim 16, further including:
code for delivering the message, for a first user device that is currently located in a service area provides a broadcast multicast service, using an eMBMS delivery procedure; and
code for delivering the message, for a second user device that is currently outside of the service area that provides the broadcast multicast service, using a short messaging service (SMS) delivery procedure.
